(19) United States
(12) Patent Application Publication
(10) Pub. No.: US 2004/0251646 A1
(43) Pub. Date: Dec. 16, 2004

(54) Universal mobile base

(76) Inventor: Steven Alden Erbach, Sumner, WA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/458,527

(22) Filed: Jun. 10, 2003

(51) Int. Cl. B62D 21/14

(52) U.S. Cl. 280/43.12

(57) ABSTRACT

A base for supporting and mobilizing equipment in accordance with the invention includes a plurality of supports interconnected by bridge members, with a wheel connected to at least one of the plurality of supports to support the base and enable the mobilization thereof, and releasable fasteners connecting the supports and bridge members and being shiftable between a release position wherein a support and bridge member are movable with respect to one another and a lock position wherein the support and bridge member are fixed with respect to one another. In a preferred form, the fasteners are manually actuated lock pins spring biased to the lock position. Also, in a preferred form, each support has a wheel connected thereto with at least one wheel having a lock.

### BACKGROUND OF THE INVENTION

This invention relates generally to a base for supporting and mobilizing equipment and, more particularly, concerns an universal mobile base capable of being adjusted to fit a variety of equipment and equipment sizes without the need for tools.

Many pieces of equipment are provided as stationary machines which cannot be readily moved or repositioned. For example, many types of wood working and metal working machines, such as tablesaws, planers, bandsaws, shapers, jointers, lathes, drill presses, and sanders, are provided with stationary bases that rest on a workshop floor. Unfortunately, many workshops do not have enough room for all the pieces of equipment needed to perform desired tasks and, therefore, require the equipment present to be moved about the shop and/or repositioned frequently. For example, in a smaller work shop, a lathe may need to be moved from an operating location into a storage location so that a drill press can be repositioned and used in the operating location.

In other instances, such equipment may need to be repositioned from time-to-time in order to optimize the use of the equipment and/or the workshop floor space. For example, as more equipment is acquired, the existing tools may need to be repositioned to make room for the new equipment.

In yet other instances, it may be helpful to allow the operator to reposition the equipment next to the subject to be worked on (or workpiece). For example, some workpieces may be of such size, shape or character that it is simply easier to bring the equipment closer to the workpiece.

Over the years, several mobile bases have been provided to accommodate the need to mobilize various types of shop equipment. For example, U.S. Pat. No. 5,940,932, issued Aug. 24, 1999 to LaHay, discloses a mobility system for heavy machinery and U.S. Pat. No. 6,095,533, issued Aug. 1, 2000 to Balolia, discloses an adjustable mobile machine base system.

Although these patents disclose systems for mobilizing normally stationary equipment, they require assembly and/or installation of the base with hand tools. This complicates the assembly and installation process and increases the amount of time it takes to mobilize equipment. They also require lock mechanisms which require at least one wheel of the assembly to be lifted off the ground so that the equipment may be fixed in a desired position or location. One problem associated with such locking mechanisms is that the equipment supported by the mobilizing systems may no longer be level with respect to the shop floor.

Accordingly, it has been determined that the need exists for an improved base for supporting and mobilizing equipment which overcomes the aforementioned limitations and which further provides capabilities, features and functions, not available in current bases and methods, and for an improved method for doing the same.

### BRIEF DESCRIPTION OF THE DRAWINGS

FIG. 1 is a perspective view of a base for supporting and mobilizing equipment embodying features of the present inventions;

FIG. 2 is an exploded perspective view of the base of FIG. 1;

FIG. 3 is a plan view of the base of FIG. 1;

FIG. 4 is a front elevational view of the base of FIG. 1;

FIG. 5 is a side elevational view of the base of FIG. 1;

FIG. 6 is a rear elevational view of the base of FIG. 1

FIG. 7A is a cross-sectional view taken along line 7-7 in FIG. 3 showing the releasable fastener in a lock position;

FIG. 7B is a cross-sectional view of the fastener of FIG. 7A showing the releasable fastener in a release position;

FIG. 8A is a cross-sectional view of an alternate fastener assembly showing the fastener in a lock position;

FIG. 8B is a cross-sectional view of the fastener of FIG. 8A showing the fastener in a release position;

FIG. 9 is a side elevational view of an alternate wheel lock shown in partially transparency; and

FIG. 10 is a perspective view of a brace for adjusting the size of a base embodying features of the present invention.

### DETAILED DESCRIPTION OF THE PREFERRED EMBODIMENTS

A base for supporting and mobilizing equipment in accordance with the invention includes a plurality of supports interconnected by bridge members, with a wheel connected to at least one of the plurality of supports to support the base and enable the mobilization thereof. The base further has releasable fasteners connecting the supports and bridge members which are shiftable between a release position wherein a support and bridge member are movable with respect to one another and a lock position wherein the support and bridge member are fixed with respect to one another. The releasable fasteners allow the base to be assembled and/or adjusted without the need for hand tools. In a preferred form, each support has a wheel connected thereto with at least one wheel having a lock, and the fasteners include manually actuated lock pins spring biased to the lock position.

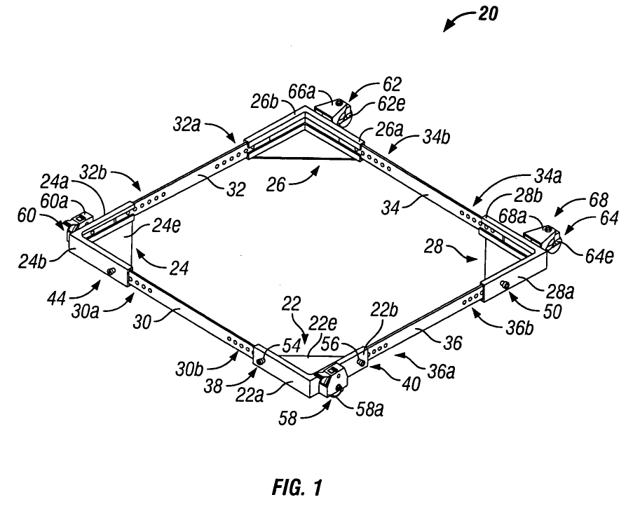

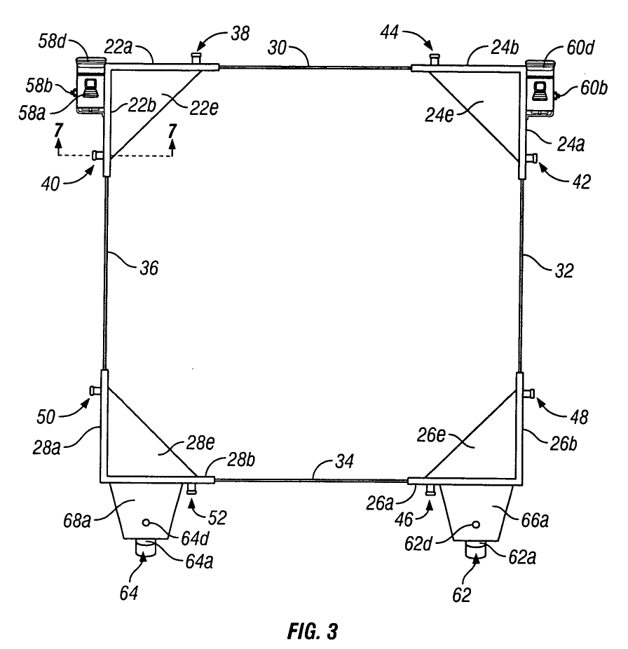

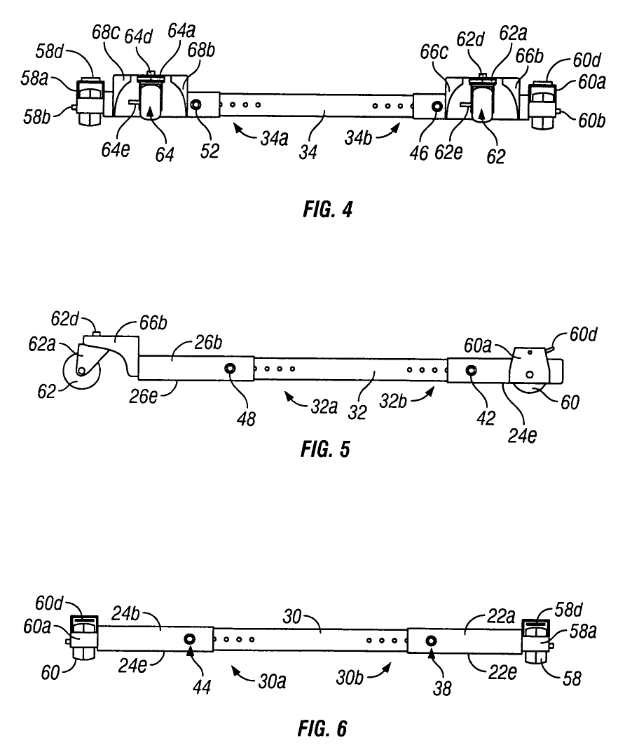

Turning now to FIGS. 1-7B, there is illustrated a base 20 embodying features of the present invention. In the embodiment illustrated, the base 20 is configured as a rectangular frame for supporting and mobilizing equipment having a generally rectangular base structure or footprint. However, the base 20 may be provided in a variety of shapes and sizes in order to support and mobilize different types of equipment (i.e., equipment having a variety of shapes, sizes or footprints).

The base 20 includes a plurality of supports 22, 24, 26 and 28 which are interconnected via bridge members 30, 32, 34 and 36 and releasable fasteners 38, 40, 42, 44, 46, 48, 50 and 52. Since the supports 22-28, bridge members 30-36 and fasteners 38-52 are substantially similar to one another, only one support, bridging member and fastener will be discussed in detail herein with similar alphabetical designators being used on corresponding portions of supports, bridge members and fasteners to reflect this similarity.

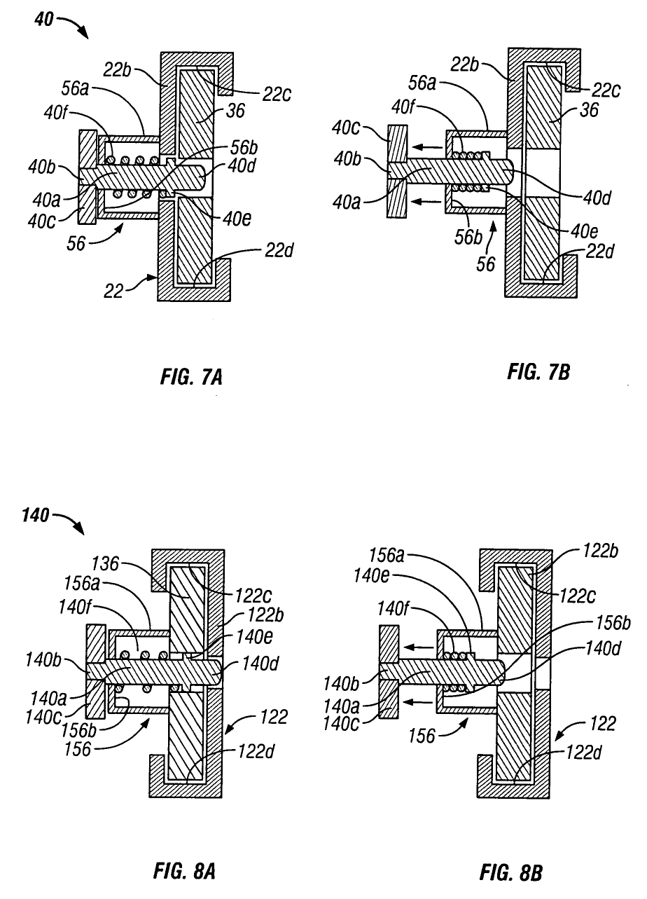

As illustrated in FIGS. 1-7B, the support 22 comprises a pair of side members 22a and 22b which define spaces for slidably receiving ends of bridge members 30 and 36, respectively. The side members 22a and 22b are generally perpendicular to one another, with each side member holding its corresponding bridge member 30 and 36 generally perpendicular to one another. In a preferred form, the side members 22a and 22b are formed from a single one-eighth inch piece of metal having a ninety degree bend about the center thereof and have outer edges folded back over the side member in order to create opposing U-shaped grooves or channels 22c and 22d (FIGS. 7A-B) to create the spaces for slidably receiving a portion of the bridge members 30 and 36. In this manner, the side members 22a and 22b form sleeves into which a portion of the bridge members 30 and 36 may be inserted.

A bottom wall, such as web 22e, connects the side members 22a and 22b and provides a surface for supporting a portion of the equipment to which the base is mounted. In a preferred form, the bottom web 22e is formed from a one-eighth inch triangular sheet of metal that is welded to side members 22a and 22b. It should be understood, however, that the web 22e may take any shape or size such as a rectangular plate, a semi-circular plate or a bar, and may be connected to a single side member rather than both side members if so desired.

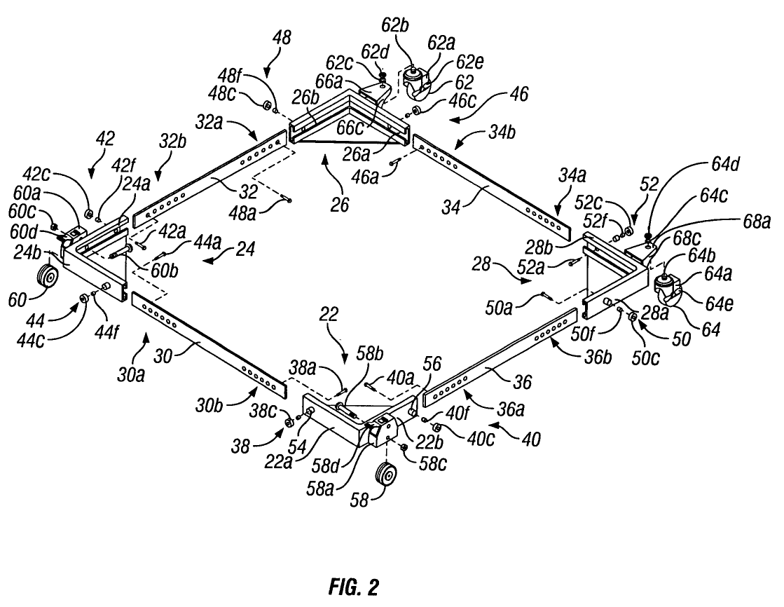

Wheels 58, 60, 62 and 64 are also connected to the supports 22-28. In a preferred embodiment, wheels 58 and 60 are fixed casters attached to opposite sides of the base 20 via supports 22 and 24. The fixed casters are positioned such that the wheels 58 and 60 rotate about a common horizontal axis passing through the axes of both wheels 58 and 60. In the embodiment illustrated, wheels 58 and 60 are supported for rotation in generally rectangular wheel housings 58a and 60a, respectively, which are bolted and/or welded to side members 22b and 24a, respectively. As illustrated in FIG. 2, the wheels 58 and 60 are connected to housings 58a and 60a via bolts 58b and 60b and nuts 58c and 60c, respectively. The bolts 58b and 60b define the horizontal axes of rotation for their respective wheels 58 and 60.

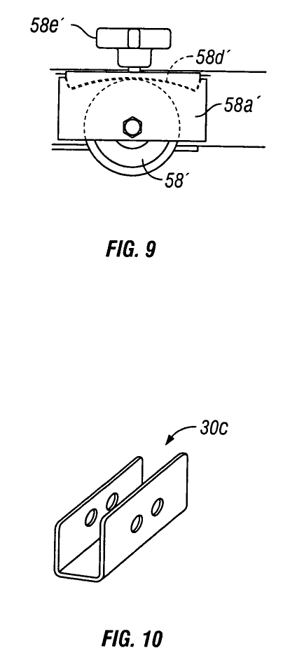

The wheels 58 and 60 further include brakes or locks 58d and 60d, which are movable between a first position wherein the wheels 58 and 60 are free to rotate and a second position wherein the wheels 58 and 60 are fixed against rotation. In the embodiment illustrated, locks 58d and 60d include cam levers which the operator my press down on or step on to move the lock into the second (or locked) position and fix the wheels against rotation, or lift up on to move the lock into the first position and allow the wheels 58 and 60 to freely rotate. More particularly, the locks 58d and 60d, which when rotated, cause the wheels 58 and 60 to be clamped into a fixed/non-rotatable position. In an alternate embodiment, however, the rectangular wheel housings 58a and 60a may include hand actuable brake assemblies. For example, in FIG. 9 an alternate fixed caster is illustrated in which a hand screw 58e′ is used to move the brake pad 58d′ into and out of engagement with the wheel 58′.

Wheels 62 and 64 are preferably swivel castors connected to supports 26 and 28 via arm members 66 and 68, respectively, so that wheels 62 and 64 can rotate about both horizontal and vertical axes. The swivel castors allow the operator to steer the base and equipment when moving or repositioning these items. Wheels 62 and 64 are mounted to U-shaped wheel brackets 62a and 64a via horizontal fasteners, such as rivets or bolts, which form the horizontal axes of rotation for each wheel 62 and 64. The wheel bracket 62a and 64a have vertical bolts 62b and 64b extending therefrom which are fed through openings defined in the top surfaces 66a and 68b of arm members 66 and 68. The brackets 62a and 64a are secured to top surfaces 66a and 68b via lock washers 62c and 64c and nuts 62d and 64d. Bolts 62b and 64b serve as the vertical axes of rotation for the swivel castors 62 and 64.

In a preferred form, wheels 62 and 64 also include brakes or locks 62e and 64e, which are movable between a first position wherein the wheels 62 and 64 are free to rotate and a second position wherein the wheels 62 and 64 are fixed against rotation. In the embodiment illustrated, the locks 62e and 64e include cam levers coupled to the horizontal fasteners of the casters which the operator my press down on to move the lock into the second position and fix the wheels against horizontal rotation, or lift up on to move the lock into the first position to allow free rotation of the wheels 58 and 60. More specifically, rotation of the cam surfaces via levers 62e and 64e causes the U-shaped brackets 62a and 64a to deflect and clamp the wheels 62 and 64, respectively, to prevent rotation of the wheel.

In the embodiment illustrated, the arms 66 and 68 are welded to the supports 26 and 28, and each arm 66 and 68 includes a set of side walls 66b and 66c and 68b and 68c extending downward from the top surfaces 66a and 68a thereof. The side walls or gusset members 66b-c and 68b-c limit the vertical axes of rotation for the wheels 62 and 64 when the locks 62e and 64e are in the second (or locked) position in order to stabilize the base 20. In a preferred form, the side walls 66b-c and 68b-c form an obstruction to the vertical rotation of the wheel locks 62e and 64e thereby limiting the vertical axis of rotation for each wheel. Although the embodiments of FIGS. 1-6 are shown with locks on each wheel, it should be understood that alternate embodiments may only provide wheel locks on one or more wheels. Furthermore, in yet other embodiments, the wheels 58-64 may be connected to the bridge members 30-36 rather than the supports 22-28, or may be connected to a combination of supports 22-28 and bridge members 30-36. Still other embodiments may use only swivel casters or only fixed castors, or may use a varying combination of each.

A guide is connected to the supports 22-28 and defines an opening through which releasable fasteners 38-52 move between the lock and release positions. In a preferred form, base 20 has two guides per support. With respect to support 22, side members 22a and 22b have guides 54 and 56. Guide 54 is for fastener 38 which connects support 22 to bridge member 30 and guide 56 is for fastener 40 which connects support 22 to bridge member 36. In a preferred form, guide 56 includes a cylindrical sleeve 56a (FIGS. 7A-B) which is made of metal and extends from the support 22 and side member 22b. The sleeve 56a preferably has a one-half inch outer diameter and a five-sixteenths inch inner diameter and further has an end cap or wall 56b enclosing the sleeve on the side opposite the side member 22b. The end cap 56b serves as a backstop for fastener spring 40f and further defines an opening through which a portion of lock pin 40a passes when fastener 40 is moved between the lock and release positions. In a preferred embodiment, the guide 56 is welded to the support 22 and the opening in the backstop 56b is slightly larger than a quarter inch in order to accommodate the fastener 40. The openings defined by the guides 54 and 56 and the supports 22-28 are preferably coaxial with one another.

As illustrated in FIGS. 7A-B, the releasable fasteners include a lock pin or shank 40a having a threaded first end 40b to which handle or gripping member 40c is connected and a rounded or beveled second end 40d which inserts into one of the plurality of openings defined by the bridge members 30-36 (which will be discussed in further detail below). A shoulder portion 40e extends from the lock pin intermediate the first and second ends 40b and 40d and is preferably located about three-fourths the way down the pin 40a from the threaded end 40b. The shoulder portion 40e serves as a backstop for the opposite end of the fastener spring 40f.

In the embodiment illustrated, the handle 40c is a disc, such as a quarter inch thick metal disc, defining a threaded bore into which pin end 40b is threaded. The circumferential surface of the handle 40c is preferably textured to assist the operator in moving the handle between the lock and release positions. Although a disc shaped handle is illustrated, the handle 40c may take many different shapes and sizes. For example, handle 40c could be provided as an enlarged rounded ball-shaped knob in order to further assist the operator in actuating the fastener.

During assembly of the fasteners 38-52, threaded pin end 40b is fed through the fastener spring 40f and the guide sleeve 56a. The handle 40c is screwed to the threaded pin end 40b extending through the opening defined by the end cap 56b. When the handle 40c is released, the spring 40f biases the pin 40a to the lock position shown in FIG. 7A so that the bridge member 36 and support 22 are no longer movable with respect to one another. When the operator pulls the handle 40c away from the guide 56, the pin 40a moves toward the release position shown in FIG. 7B compressing spring 40f between the end cap 56b and the shoulder portion 40e so that the bridge member 36 and support 22 are now slidably movable with respect to one another.

As illustrated in FIGS. 1-7B, the bridge members 30-36 comprise beams for interconnecting the supports 22-28. The beams 30-36 form elongated bars connecting the supports 22-28 to one another and have a generally rectangular cross section. With respect to the beams illustrated, beam 30 preferably comprises an one-eighth inch thick elongated metal bar having first and second ends 30a and 30b. Each end 30a and 30b defines a plurality of openings through which a portion of fasteners 38-52 may pass. In a preferred form, the ends 30a and 30b define six openings or holes which allow for the supports 22-28 to be interconnected at a variety of distances from one another in order to account for equipment of different sizes. For example, the supports 22 and 24 may be connected to the beam 30 via the outermost openings defined by ends 30a and 30b in order to accommodate a larger piece of equipment, or may be connected using the innermost openings defined by ends 30a and 30b in order to accommodate a smaller piece of equipment. Thus, base 20 forms a universal mobile base assembly which may be used with a variety of equipment. Beams of differing lengths, cross-sections, and materials may also be provided so that the base 20 may be used to facilitate different uses.

Some equipment may have accessories or other attachments which increase the overall size of the machine beyond the standard footprint of the machine itself. For example, some table saws have extended tables or stands for working with larger workpieces, which increases the overall length of the machine beyond the machines standard footprint, but does not increase the machine's overall width. In such instances, the base 20 may be adjusted by either using longer bridge members 30-36 or by adding additional bridge members 30-36 and connecting the bridge members 30-36 together via the extension brace or coupler 30c illustrated in FIG. 10. The extension brace 30c allows two shorter bridge members 30-36 to be connected together to form a longer bridge member and account for the added length of the machine. In the embodiment illustrated, the brace 30c is U-shaped and has two sets of holes located opposite each other on the sides of the brace. The brace 30c is fastened to the ends of two bridge members via fasteners which are fed through the openings located on one side of the extension brace, through corresponding openings located in the ends of the bridge members, and through the openings located on the opposite side of the brace 30c. A second set of bridge members 30-36 are connected in a similar fashion and then the extended bridge members are connected to the supports 22-28 of the base 20 in the manner discussed herein so that the enlarged machine maybe mounted thereto. Although the extension brace 30c may be fastened to the bridge members 30-36 via a variety of fasteners such as screws, bolts or rivets, a preferred embodiment attaches the brace via hand operated fasteners such as wing screws/bolts and nuts or thumb screws/bolts and nuts. Thus, the extension brace 30c and base 20 can be assembled without the need for hand tools.

During the assembly of base 20, the bridge members 30-36 are inserted into the supports 22-28. With respect to supports 22 and 24 and bridge member 30, the end 30a of bridge member 30 is inserted into the space defined by the opposing U-shaped channels of side member 24b and the fastener 44 is moved to the release position. The bridge member 30 continues to be inserted into the support sleeve of side member 24b until the fastener 44 reaches one of the plurality of openings defined by end 30a of bridge member 30 and returns to the lock position. If desired, the fastener 44 may be manually actuated back to the release position so that the bridge member 30 may be inserted further into the sleeve of the support 24. This step may be repeated until either the desired length is reached, the last opening defined by the end of the bridge member has been reached or until the end of the bridge member reaches an end stop such as the generally perpendicular side member (e.g., the end stop created by the ninety degree bend in the support).

Once end 30a is inserted into the sleeve by the desired amount and the fastener 44 has returned to the lock position thereby securing end 30a to side member 24b, end 30b may be inserted into the slot defined by the side member 22a of support 22. As with end 30a, end 30b is inserted into the support sleeve 22a until the fastener 38 reaches one of the plurality of openings defined by end 30b of bridge member 30 and returns to the lock position. The fastener 38 may again be manually actuated back to the release position so that the bridge member 30 may be inserted to the desired position within support sleeve 22a. These assembly steps are continued until each of the supports 22-28 are interconnected via bridge members 30-36.

In a preferred embodiment base 20 may be supplied in two separate sizes, with one size having a set of bridge members which allow the base to be adjusted between an eighteen by eighteen inch square and a twenty-eight by twenty-eight inch square, and another size having a set of bridge members which allow the base to be adjusted between a twenty-four by twenty-four inch square and a thirty-four by thirty-four inch square. The metal construction of these bases will allow the base to hold approximately six-hundred to twelve-hundred pound loads. In addition, the releasable fasteners provide a quick release mechanism which allows for quick assembly and adjustments to be made to the base without the need for hand tools. Furthermore, the low profile of the base 20 allows the equipment supported and mobilized by the base to remain only approximately one-half inch off of the workshop surface or floor.

Although the embodiment discussed thus far has bridge members defining a plurality of openings and guides connected to the supports, it should be understood that the supports may define a plurality of openings and the guides may be connected to the bridge members. For example, in FIGS. 8A-B, there is illustrated an alternate embodiment wherein the guide is connected to the bridge member rather than the support. For convenience, those items which are similar to items discussed above with respect to FIGS. 1-7B have been numbered similarly with the exception of adding the prefix “1.” In FIGS. 8A-B, the guide 156 is connected to the bridge member 136 and the support 122 defines a space for slidably receiving an end of bridge member 136. More particularly, the support 122 has opposing U-shaped channels 122c and 122d which form a support sleeve 122b into which an end of bridge member 136 is inserted. The fastener 140 is moved to the release position illustrated in FIG. 8B until the fastener returns to the lock position. Since the support sleeve 122b defines a plurality of openings, the fastener 140 may be manually moved to the release position until the bridge member 136 has been inserted into the support sleeve 122b by the desired amount and the fastener 140 has returned to the lock position.

In yet other embodiments, the bridge members 30-36 may define spaces to slidably receive supports 22-28. For example, in one embodiment, the bridge members 30-36 may have opposing U-shaped channels within which generally rectangular supports 22-28 may be inserted. One can visualize a few of these alternate embodiments by looking at FIGS. 7A-8B and swapping the reference numerals so that numerals 36 and 136 represent the side members of the supports and numerals 22 and 122 represent the bridge members. Furthermore, in these alternate embodiments, the guides may be mounted to either the supports or the bridge members as discussed above with respect to FIGS. 7A-8B.

It should also be understood that the C-shape and rectangular shape of the supports and bridge members are not the only configuration in which these items may be implemented. For example, in alternate embodiments, the supports or bridge members may comprise an enclosed tube of round or rectangular cross section, with the other of the supports and bridge members comprising a shape to fit over or within the enclosed tube.

Thus it is apparent that there has been provided, in accordance with the invention, a base for supporting and mobilizing equipment and a method for assembling the same that fully satisfy the objects, aims, and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

1. (Currently Amended) A base for supporting and mobilizing equipment comprising:
a plurality of supports;
bridge members for interconnecting the plurality of supports;
a wheel connected to at least one of the plurality of supports to support the base and enable mobilization of the base; and
at least one releasable fastener fasteners connecting at least one of the supports and at least one of the bridge members, the each fastener being shiftable between a release position wherein the support and bridge member are movable with respect to one another and a lock position wherein the support and bridge member are fixed with respect to one another.

2. (Currently Amended) The base of claim 1 wherein each of the releasable fastener fasteners is attached to one of the supports or bridge members.

3. (Original) The base of claim 2 wherein the fastener is biased to the lock position.

4. (Currently Amended) The base of claim 3 wherein the fastener is fasteners are manually actuated to the release position.

5. (Currently Amended) The base of claim 4 wherein the each fastener has a lock pin biased in the lock position and manually moveable to the release position.

6. (Currently Amended) The base of claim 5 wherein the each fastener includes a guide for restricting movement of the lock pin.

7. (Currently Amended) The base of claim 6 wherein the each fastener includes a spring disposed in the guide biasing the lock pin into the lock position and capable of being compressed to permit the lock pin to be moved to the release position.

8. (Original) The base of claim 1 wherein each support defines a space to slidably receive at least one bridge member.

9. (Original) The base of claim 4 wherein each support includes a pair of side members that define spaces for slidably receiving at least one bridge member, and a bottom web connecting the side members.

10. (Original) The base of claim 1 wherein each bridge member comprises a beam having a generally rectangular cross section and defining a plurality of openings through which the fastener passes when in the lock position, the plurality of openings allowing the base to be adjusted to a variety of sizes to accommodate equipment of various sizes.

11. (Original) The apparatus of claim 1 wherein at least one of the wheels swivels and has a wheel lock, the wheel lock being movable between a first position wherein the wheel is free to rotate and a second position wherein the wheel is fixed against rotation.

12. (Original) The base of claim 1 wherein the plurality of supports comprises four corner plates with each corner plate being connected to another corner plate via a bridge member and having at least one wheel connected thereto with the at least one wheel having a lock capable of moving between a first position wherein the connected wheel is free to rotate and a second position wherein the wheel is fixed against rotation.

13. (Original) The base of claim 12 wherein at least two wheels comprise swivel castors with wheel locks located on each castor.

14. (Original) The apparatus of claim 13 further comprising at least one arm connecting at least one wheel to a corner plate, the arm having walls extending therefrom and about the wheels for limiting rotation of the wheel about the vertical axis when the lock connected to the wheel is in the second position.

15. (Original) The base of claim 12 wherein first and second wheels are fixedly connected to first and second corner plates and are capable of rotating only about a horizontal axis, and third and fourth wheels comprise castors fixedly connected to third and fourth corner plates and are capable of rotating about a horizontal axis and a vertical axis.

16. (Original) The base of claim 15 wherein the lock is connected to at least one of the first and second wheels and movable between a first position wherein the connected wheel is freely movable to facilitate apparatus mobility and a second position wherein the wheel is fixed in order to prevent movement of at least a portion of the apparatus.

17. (Original) The base of claim 1 further comprising an extension brace defining a space for receiving a portion of at least two bridge members and securing the bridge members together for adjusting the size of the base to accommodate larger equipment.

18. (Presently Amended) The apparatus of claim 5 wherein at least one of the each bridge members member has a sleeve defining a cavity into which a spring is disposed and to which the post is connected, the spring normally biasing the post in the lock position and capable of being compressed between an end of the post and the sleeve to place the post in the release position.

19. (Canceled)

20. (Canceled)
